(19) United States
(12) Patent Application Publication
(10) Pub. No.: US 2012/0049663 A1
(43) Pub. Date: Mar. 1, 2012

(54) ROTOR AND METHOD OF FORMING SAME

(75) Inventors: Raja K. Mishra, Shelby Township, MI (US); Thomas A. Perry, Bruce Township, MI (US); Anil K. Sachdev, Rochester Hills, MI (US)

(73) Assignee: GM GLOBAL TECHNOLOGY OPERATIONS, INC., Detroit, MI (US)

(21) Appl. No.: 12/873,614

(22) Filed: Sep. 1, 2010

(51) Int. Cl. H02K 15/12; H02K 15/03

(52) U.S. Cl. 310/44; 29/598

(57) ABSTRACT

A method of forming a rotor of an electromagnetic device includes substantially filling a channel defined by a lamination stack and having a curvilinear cross-section with a slurry including a polymer and a plurality of permanent magnetic particles each having a magnetic moment, applying a magnetic field having a plurality of magnetic field lines arranged in a predetermined geometry to the slurry in situ within the channel to thereby align the magnetic moment of each permanent magnetic particle along the field, and curing the polymer to permanently align the magnetic moment of each permanent magnetic particle along the field and thereby dispose a permanent magnet within the channel to form the rotor, wherein the permanent magnet abuts the stack and substantially fills the channel whereby the channel is substantially free from an air gap between the stack and the permanent magnet. A rotor formed by the method is also disclosed.

### TECHNICAL FIELD

The present disclosure generally relates to a rotor for an electromagnetic device and a method of forming the rotor.

### BACKGROUND

Electromagnetic devices such as electric motors, generators, and traction motors are useful for converting one form of energy to another. For example, an electric motor may convert electrical energy to mechanical energy through the interaction of magnetic fields and current-carrying conductors. In contrast, a generator or dynamo may convert mechanical energy to electrical energy. And, other electromagnetic devices such as traction motors for hybrid vehicles may operate as both an electric motor and/or a generator.

Electromagnetic devices often include an element rotatable about a central longitudinal axis. The rotatable element, i.e., a rotor, may be coaxial with a static element, i.e., a stator, and energy may be converted via relative rotation between the rotor and stator.

### SUMMARY

A rotor for an electromagnetic device includes a lamination stack defining a plurality of channels therethrough, wherein the plurality of channels is arranged annularly about a central longitudinal rotor axis and wherein each channel has a curvilinear cross-section. The rotor also includes a plurality of permanent magnets disposed respectively within each channel whereby each channel is substantially filled with the permanent magnet. Each of the permanent magnets includes a plurality of permanent magnetic particles dispersed within a polymer, and each of the permanent magnetic particles has a magnetic moment permanently aligned along a magnetic field.

A method of forming a rotor of an electromagnetic device includes substantially filling a channel defined by a lamination stack and having a curvilinear cross-section with a slurry including a polymer and a plurality of permanent magnetic particles, wherein each permanent magnetic particle has a magnetic moment. The method also includes applying a magnetic field having a plurality of magnetic field lines arranged in a predetermined geometry to the slurry in situ within the channel to thereby align the magnetic moment of each permanent magnetic particle along the magnetic field. In addition, the method includes curing the polymer to permanently align the magnetic moment of each permanent magnetic particle along the magnetic field and thereby dispose a permanent magnet within the channel to form the rotor. The permanent magnet abuts the lamination stack and substantially fills the channel, whereby the channel is substantially free from an air gap between the lamination stack and the permanent magnet.

In one variation, a method of forming a rotor of an electromagnetic device includes combining a polymer and a plurality of permanent magnetic particles, each having a magnetic moment, to form a slurry. The method also includes injecting the slurry in a liquid phase into each of a plurality of channels defined by a lamination stack to thereby substantially fill each channel with the slurry. The plurality of channels is arranged annularly about a central longitudinal rotor axis, and each channel has a curvilinear cross-section. After injecting, the method includes applying a magnetic field having a plurality of magnetic field lines arranged in a predetermined geometry to the slurry in situ within each channel to thereby rotate at least a portion of the plurality of permanent magnetic particles so as to orient the magnetic moment of each permanent magnetic particle along the magnetic field. Concurrent with applying, the method includes curing the polymer in situ within each channel to permanently align the magnetic moment of each permanent magnetic particle along the magnetic field and thereby dispose a permanent magnet having a curvilinear cross-section within each channel. The permanent magnet abuts the lamination stack and substantially fills each channel, whereby each channel is substantially free from an air gap between the lamination stack and the permanent magnet. After curing, the method includes removing the magnetic field from the permanent magnet without rotation of any of the permanent magnetic particles to thereby form the rotor.

The method forms a rotor having a custom, controllable magnetic profile. That is, since the rotor includes the permanent magnet having a curvilinear cross-section, the operating magnetic field of the rotor may be tailored for a desired application, and torque ripple may be reduced. Further, since the rotor is substantially free from air gaps between the lamination stack and the permanent magnet, the rotor exhibits the same magnetic flux from a lesser quantity of permanent magnetic particles without sacrificing torque output. The method also enables efficient and cost-effective manufacturing of the rotor since the rotor does not include discreet, rectilinear magnets within the channels of the rotor that require tedious hand-assembly.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic exploded perspective view of a comparison rotor including individual permanent magnets disposed within a plurality of channels defined by a lamination stack of the rotor;

FIG. 2 is a schematic perspective cut-away view of a portion of the rotor of FIG. 1;

FIG. 3 is a schematic partial perspective view of a rotor of an electromagnetic device including a lamination stack defining a plurality of channels therethrough, wherein each channel has a curvilinear cross-section and is substantially filled with a permanent magnet;

FIG. 4 is a schematic perspective partial view of the rotor of FIG. 3, and a nozzle for substantially filling each channel of the rotor with a slurry;

FIG. 5 is a schematic magnified view of a portion of the slurry of FIG. 4 before a magnetic field having a plurality of magnetic field lines arranged in a predetermined geometry is applied to the slurry to form the permanent magnet of FIG. 3; and

FIG. 6 is a schematic magnified fragmentary view of a portion of the permanent magnet of FIG. 3 including the plurality of magnetic particles each having a magnetic moment permanently aligned along the magnetic field after the magnetic field has been applied to the slurry of FIGS. 4 and 5.

### DETAILED DESCRIPTION

Referring to the Figures, wherein like reference numerals refer to like elements, a rotor 10 and stator 12 for an electromagnetic device 14 are shown in FIG. 3. As set forth in more detail below, the rotor 10 may be useful for applications requiring electromagnetic devices 14 having excellent torque output and minimized torque ripple. For example, the electromagnetic device 14 may be configured as an electric motor, a generator, a combined electric motor/generator, or another electric machine that may be useful for applications including, but not limited to, traction motors for hybrid vehicles and interior permanent magnet motors for transportation applications.

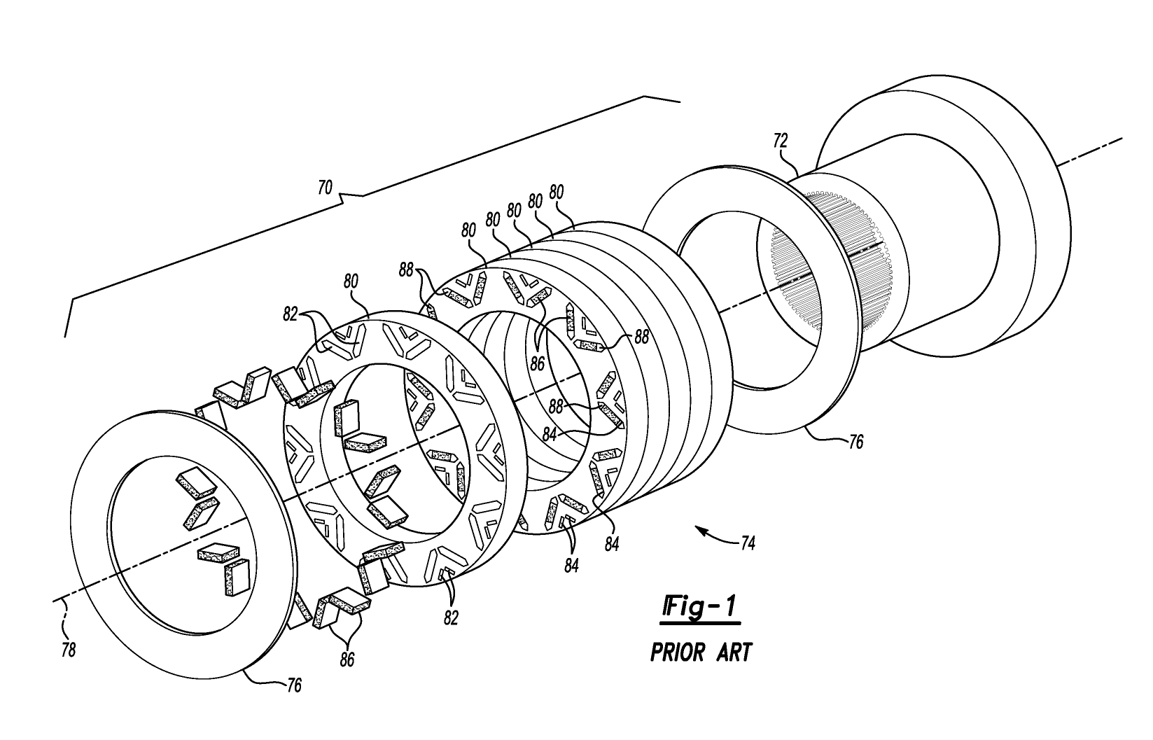

By way of general explanation, a comparison rotor 70 is described generally with reference to FIG. 1. The rotor 70 may surround a hub 72, such as a motor hub, and may include a lamination stack 74 disposed between two end rings 76 along a central longitudinal axis 78 of the rotor 70. More specifically, the lamination stack 74 is generally formed from a plurality of steel laminations 80 stacked adjacent one another axially along the central longitudinal axis 78. As used herein, the terminology “steel laminations” refers to a grade of steel, often including silicon, tailored to produce desired magnetic properties, e.g., low energy dissipation per cycle and/or high permeability, and suitable for carrying magnetic flux. For example, although not shown to scale in FIG. 1 for purposes of illustration, the steel laminations 80 may be die cut into circular layers or laminations having a thickness of less than or equal to about 2 mm. The circular layers may then be stacked adjacent one another to form the lamination stack 74. That is, the lamination stack 74 of FIG. 1 may be in the form of cold-rolled strips of steel laminations 80 stacked together to form a core of the comparison rotor 70.

With continued reference to FIG. 1, each steel lamination 80 defines a plurality of cut-outs 82 arranged about the central longitudinal axis 78. Therefore, when individual steel laminations 80 are stacked adjacent one another as shown in FIG. 1, the lamination stack 74 defines a plurality of symmetric channels 84 therethrough.

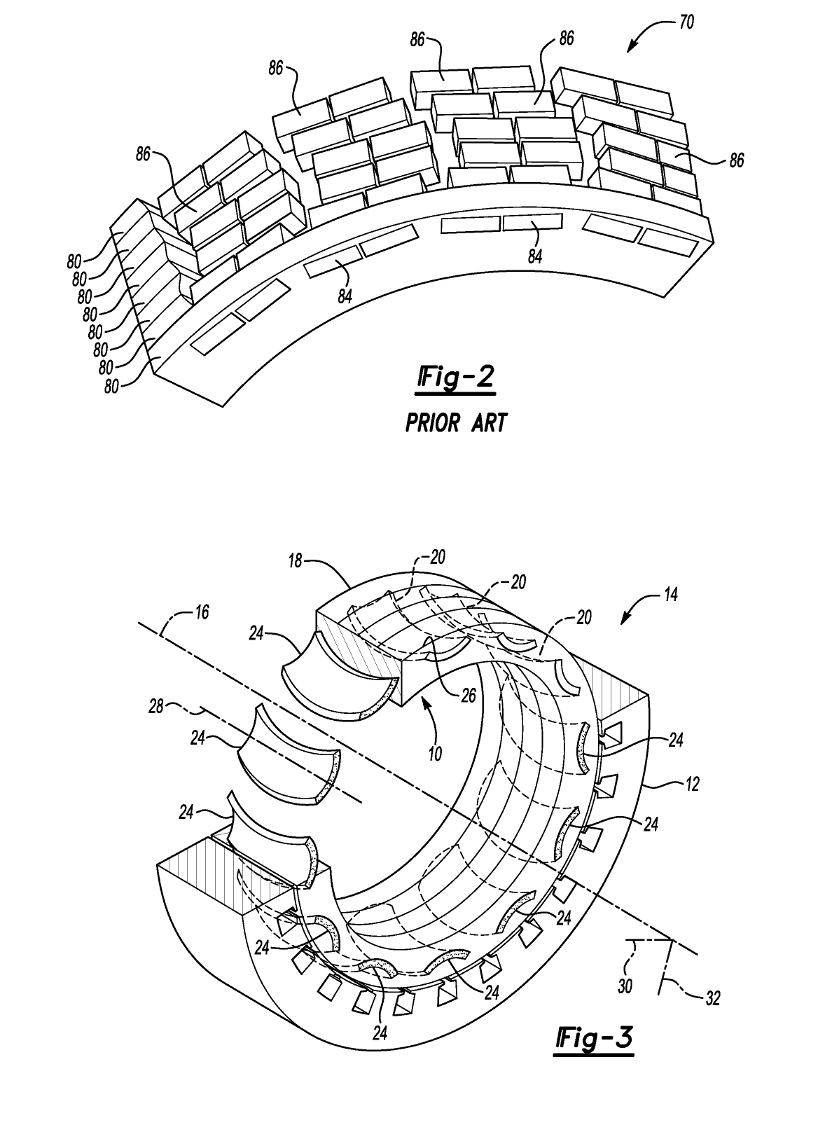

The rotor 70 also includes a plurality of individual, symmetric, rectilinear magnets 86 stacked adjacent one another axially along the central longitudinal axis 78, as shown in FIGS. 1 and 2. The individual, symmetric, rectilinear magnets 86 do not fill all remnant space within the channels 84 and, as such, define a plurality of air gaps 88 (FIG. 1) between the lamination stack 74 and the rectilinear magnets 86. Further, groups of individual steel laminations 80 may be skewed with respect to each other, and the individual, rectilinear magnets 86 may therefore also be skewed with respect to each other, as best shown in FIG. 2.

Referring now to FIG. 3, the rotor of the present disclosure is shown generally at 10. For purposes of illustration, only a portion of each of the rotor 10 and stator 12 is shown in FIG. 3. However, in operation, each of the rotor 10 and the stator 12 may have an annular shape. By way of general explanation, the electromagnetic device 14 functions through relative rotation between the rotor 10 and the stator 12 about a central longitudinal rotor axis 16. Although the rotor 10 is shown disposed within the stator 12 in FIG. 3, i.e., disposed in closer proximity to the central longitudinal rotor axis 16 as compared to the stator 12, the stator 12 may alternatively be disposed within the rotor 10.

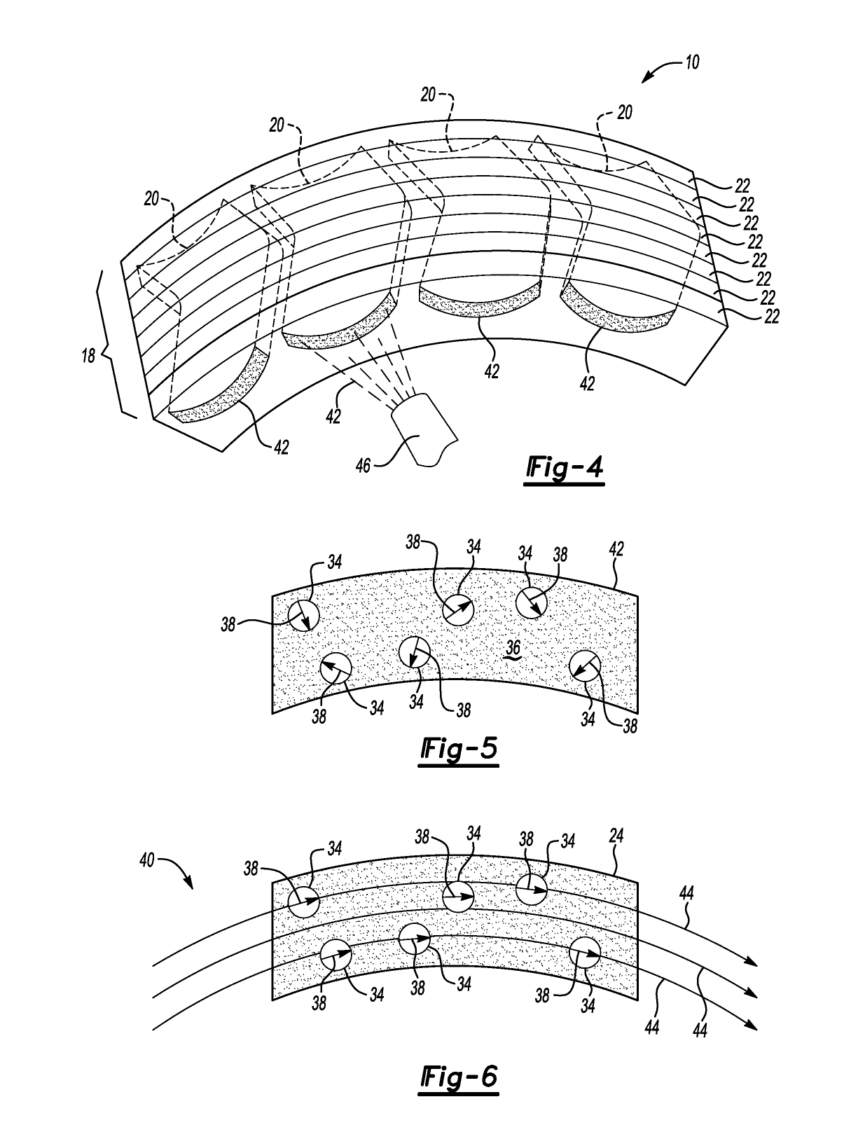

As shown in FIGS. 3 and 4, the rotor 10 includes a lamination stack 18 defining a plurality of channels 20 therethrough. The lamination stack 18 may be formed from a plurality of individual steel laminations 22 (FIG. 4) stacked adjacent one another axially along the central longitudinal rotor axis 16. That is, individual steel laminations 22 may be stacked adjacent one another so as to define the plurality of channels 20 through the lamination stack 18. Although dependent upon the desired application of the electromagnetic device 14, the lamination stack 18 may have an outside diameter of from about 100 mm to about 250 mm. However, larger and smaller lamination stacks 18 are also contemplated.

For purposes of illustration, only three and four channels 20 are specifically referenced in FIGS. 3 and 4, respectively. However, the number of channels 20 for a desired application may be determined according to electromagnetic principles appreciated by one skilled in the art. By way of non-limiting examples, the lamination stack 18 may define from 8 to 16 channels 20. Additionally, as shown in FIG. 3, the plurality of channels 20 is arranged annularly, i.e., in a ring shape, about the central longitudinal rotor axis 16. Such annular arrangement of the channels 20 about the central longitudinal rotor axis 16 generally minimizes a likelihood of the rotor 10 generating axial forces relative to the stator 12 during operation.

As further shown in FIG. 4 and set forth in more detail below, each channel 20 has a curvilinear cross-section. As used herein, the terminology “curvilinear” refers to a shape characterized by following a curved line composed of at least one arcuate section, i.e., a shape that is non-rectilinear. For example, the channel 20 may be continuously curvilinear or may have an arcuate portion. Therefore, each channel 20 is non-rectilinear and may be defined by smooth, flowing, curving lines. Additionally, each of the plurality of channels 20 may have a substantially similar shape. That is, each of the plurality of channels 20 may be parallel to each other when arranged annularly about the central longitudinal rotor axis 16. Further, each of the plurality of channels 20 may be substantially equally spaced apart from each of two adjacent channels 20 so as to form the annular configuration shown in FIG. 3. Such equal spacing between each channel 20 generally contributes to optimized torque output of the electromagnetic device 14.

Referring again to FIG. 3, the rotor 10 also includes a plurality of permanent magnets 24. As used herein, the terminology “permanent magnet 24” refers to a material or object that produces a magnetic field and has irreversible magnetism. That is, each of the permanent magnets 24 is magnetized, e.g., by an electrical current, and creates its own persistent, permanent magnetic field that does not demagnetize. Stated differently, in contrast to soft magnets, the magnetism of the permanent magnets 24 is retained even after being removed from a magnetic field. For example, each of the permanent magnets 24 may retain its magnetism after being magnetized by electrical current, and thereafter does not rely on external influences to generate a magnetic field, and does not demagnetize in the absence of electrical current. The permanent magnets 24, in contrast to a soft magnet, are also highly anisotropic, i.e., directionally dependent, and have properties that differ according to a direction of measurement.

As best shown in FIG. 3, the plurality of permanent magnets 24 is disposed respectively with each channel 20 whereby each channel 20 is substantially filled with the permanent magnet 24. That is, referring to FIG. 3, each of the permanent magnets 24 may abut the lamination stack 18 whereby each channel 20 is substantially free from an air gap 88 (FIG. 1) between the lamination stack 18 and the permanent magnet 24. Stated differently, each of the permanent magnets 24 substantially fills an entirety of each channel 20 so that any open, remnant space within the channel 20 is filled with the permanent magnet 24.

Referring again to FIG. 3, since each of the channels 20 has a curvilinear cross-section as set forth above, the permanent magnet 24 disposed within each channel 20 may likewise have a non-rectilinear shape. More specifically, referring to FIG. 3, each of the permanent magnets 24 may have a curvilinear cross-section within each channel 20 in a plane substantially parallel to the central longitudinal rotor axis 16. For example, the permanent magnet 24 within each channel 20 may have an overall curvilinear shape as shown in FIGS. 3 and 4. When sliced longitudinally, i.e. in a plane substantially parallel to the central longitudinal rotor axis 16, the permanent magnet 24 within each channel 20 may have, for example, a curved, bowed cross-section. That is, the permanent magnet 24 may bow toward the central longitudinal rotor axis 16 so as to be incurvate with respect to an exterior surface 26 (FIG. 3) of the rotor 10. In addition, the permanent magnet 24 may form a curved V-shape, as best shown in FIG. 4. Advantageously, the curvilinear cross-section of the permanent magnet 24 may allow skewing of the permanent magnets 24 about the rotor 10 with respect to a longitudinal axis 28 (FIG. 3) of the permanent magnet 24.

Likewise, with continued reference to FIG. 3, each of the permanent magnets 24 may have a curvilinear cross-section within each channel 20 in a plane substantially perpendicular to the central longitudinal rotor axis 16. Therefore, when sliced laterally, i.e., in a plane substantially perpendicular to the central longitudinal rotor axis 16, the permanent magnet 24 within each channel 20 may have, for example, a curved, bowed cross-section as shown in FIG. 4. That is, the permanent magnet 24 may bow inward with respect to the central longitudinal rotor axis 16 (FIG. 3).

Therefore, it is to be appreciated that the permanent magnet 24 within each channel 20 may be curvilinear in three dimensions, i.e., in the x-, y-, and z-axes (shown at 30, 16, and 32 respectively in FIG. 3). That is, the permanent magnet 24 within each channel 20 may be tailored to fit any shape of the plurality of channels 20 and may have any curvilinear shape. For example, the permanent magnet 24 within each channel 20 may have a shape such as, but not limited to, a helical shape, a skewed shape, a winding shape, a bowed shape, a torsional shape, an undulating shape, and combinations thereof. In one non-limiting example, although not shown, the permanent magnet 24 may have a sinuous or undulating, winding shape. That is, the permanent magnet 24 may bow both inward and outward with respect to the central longitudinal rotor axis 16 so as to be both curvate and incurvate with respect to the exterior surface 26 (FIG. 3) of the rotor 10 and form a curved S-shape. Consequently, the rotor 10 may be tailored to provide the electromagnetic device 14 having an operating magnetic field of any shape or geometry, as set forth in more detail below.

Referring now to FIGS. 5 and 6, each of the permanent magnets 24 (FIG. 6) includes a plurality of permanent magnetic particles 34 dispersed within a polymer 36 (FIG. 5). Although illustrated schematically as spheres in FIGS. 5 and 6, the plurality of permanent magnetic particles 34 may have any shape. For example, the permanent magnetic particles 34 may be flakes, chips, powder, spheres, and combinations thereof. And, each of the plurality of permanent magnetic particles 34 may have a particle size of from about 10 microns to about 40 microns, more specifically, from about 15 microns to about 30 microns. Such particle size allows for adequate dispersal of the plurality of permanent magnetic particles 34 within the polymer 36, and allows the permanent magnetic particles 34 to rotate within the polymer 36, as set forth in more detail below.

As illustrated schematically in FIG. 6, each permanent magnetic particle 34 has a magnetic moment (represented generally by individual arrows 38) permanently aligned along a magnetic field 40. By way of general explanation, the magnetic moment 38 of each permanent magnetic particle 34 is a vector that characterizes the overall magnetic properties of the permanent magnetic particle 34 and is a measure of a tendency of the permanent magnetic particle 34 to align with the magnetic field 40. The magnetic moment 38 has both a magnitude and direction. In contrast to FIG. 5, the magnetic moment 38 of each permanent magnetic particle 34 of the permanent magnet 24 of FIG. 6 is permanently aligned along the magnetic field 40, as set forth in more detail below.

Suitable permanent magnetic particles 34 include, but are not limited to, ferromagnetic and/or ferromagnetic materials including, but not limited to, iron, nickel, cobalt, lodestone, alloys of rare earth metals (i.e., scandium, yttrium, and the fifteen lanthanides including the fourteen elements having atomic numbers 58 through 71 and lanthanum), and combinations thereof. For example, the plurality of permanent magnetic particles 34 may be formed from neodymium with a three component system in which iron and boron have been added to neodymium (Nd—Fe—B), a samarium-cobalt magnet made of a two-component system alloy of samarium and cobalt (Sm—Co), and/or a samarium-iron-nitrogen system (Sm—Fe—N).

Referring again to FIG. 5, the plurality of permanent magnetic particles 34 is dispersed within the polymer 36, as set forth above. For example, the permanent magnetic particles 34 may be randomly dispersed within the polymer 36 so that the permanent magnetic particles 34 are spaced apart from one another. Therefore, the permanent magnet 24 may be a random combination or mixture of the permanent magnetic particles 34 and the polymer 36 so that some of the permanent magnetic particles 34 are spaced closer to adjacent permanent magnetic particles 34 than others. Alternatively, the plurality of permanent magnetic particles 34 may be equally spaced throughout the polymer 36. In general, it is desirable to maximize a concentration of the permanent magnetic particles 34 within the polymer 36 to provide the rotor 10 with excellent magnetic properties and operating characteristics, as set forth in more detail below.

The polymer 36 may be selected according to the desired application of the rotor 10 and permanent magnet 24. For example, for automotive applications, the polymer 36 may be selected to be suitable for operating temperatures of from about −75° C. to about 180° C. The polymer 36 may have a melting point temperature of greater than about 300° C. Further, the polymer 36 may be selected to have suitable viscosity so that the plurality of permanent magnetic particles 34 dispersed within the polymer 36 may be poured, injected, or otherwise inserted into the plurality of channels 20 (FIG. 3) of the rotor 10. For example, the polymer 36 may have a viscosity of from about 1,000 cP to about 10,000 cP at a temperature of 25° C. The polymer 36 may be cured via an activation catalyst, via an increase or decrease in temperature, or by any suitable curing mechanism recognizable by one skilled in the art. Suitable polymers 36 include, but are not limited to, thermoplastic polymers, thermoset polymers, and combinations thereof. More specifically, the polymer 36 may be selected from nylon, polyphenylenesulfide, ethylene-ethylacrylate, polyesters, polyesteramides, epoxies, polyimides, and combinations thereof.

The rotor 10 exhibits minimized torque ripple. By way of general explanation, torque ripple is equivalent to a difference between minimum torque and maximum torque during one revolution of the rotor 10. Torque ripple is an indicator of inefficiency of the rotor 10 and electromagnetic device 14. Torque ripple therefore prevents smooth rotation of the rotor 10 and may generate noise. Since the rotor 10 allows for channels 20 having a curvilinear cross-section, the permanent magnet 24 disposed within each channel 20 is also curvilinear, minimizes air gaps 88 (FIG. 1), and can be shaped to compensate for and/or overcome undesirable operating characteristics such as torque ripple.

A method of forming the rotor 10 is also described herein with reference to FIGS. 3-6. The method includes substantially filling the channel 20 (FIG. 4) defined by the lamination stack 18 (FIGS. 3 and 4) and having a curvilinear cross-section with a slurry 42 (FIGS. 4 and 5) including the polymer 36 (FIG. 5) and the plurality of permanent magnetic particles 34 (FIGS. 5 and 6), wherein each permanent magnetic particle 34 has the magnetic moment (arrows 38 of FIGS. 5 and 6). The channel 20 (FIGS. 3 and 4) may be substantially filled via any suitable process. For example, substantially filling may include injecting the slurry 42 into the channel 20 in a liquid phase under pressure. That is, the polymer 36 including the plurality of permanent magnetic particles 34 may be uncured, and may be flowable and injectable into the channel 20 by, for example, an injection nozzle 46 (FIG. 4) or other suitable device. The slurry 42 may be injected in the liquid phase under a suitable pressure to substantially fill the channel 20 without damaging the lamination stack 18 (FIG. 4). Although the pressure of injection will vary according to the polymer 36 selected for a desired application, the channel 20 may be substantially filled by injecting the slurry 42 into the channel 20 at a pressure of from about 20 kPa to about 70 kPa.

Further, substantially filling may include injecting the slurry 42 into the channel 20 without heating the slurry 42 above ambient temperature, e.g., above 25° C. That is, the slurry 42 may not require additional fluidizing before injection into the channel 20. That is, the slurry 42 may not preexist in solid form, for example, before being melted for injection into the channel 20. Rather, the slurry 42 may be injected into the channel 20 in liquid form without additional heating.

As set forth above and described with reference to FIGS. 3-5, the channel 20 is substantially filled so that the slurry 42 (FIG. 4) abuts the lamination stack 18 whereby the channel 20 is substantially free from any air gap 88 (FIG. 1) or open space between the lamination stack 18 and the slurry 42. That is, the slurry 42 substantially fills the entire curvilinear cross-section of the channel 20.

Referring again to FIGS. 5 and 6, the method further includes applying the magnetic field 40 (FIG. 6) having a plurality of magnetic field lines 44 arranged in a predetermined geometry to the slurry 42 in situ within the channel 20 (FIG. 4) to thereby align the magnetic moment 38 of each permanent magnetic particle 34 along the magnetic field 40. As used herein, the terminology “in situ” refers to applying the magnetic field 40 in place, i.e., to the slurry 42 within the channel 20 (FIG. 3) after the channel 20 has been substantially filled with the slurry 42. The magnetic field 40 may be applied via any suitable process and/or device. For example, the magnetic field 40 may be applied to the slurry 42 in situ within the channel 20 by surrounding the channel 20 and slurry 42 with a conductor (not shown), such as a coil of wire, carrying an electric current which generates the magnetic field 40. Alternatively, the magnetic field 40 may be applied to the slurry 42 in situ within the channel 20 by surrounding the channel 20 and/or slurry 42 with another permanent magnet (not shown) external to the lamination stack 18.

The magnetic field 40 may have any geometry or shape. For example, although the plurality of magnetic field lines 44 are shown schematically as having a generally arced shape in FIG. 6, the plurality of magnetic field lines 44 may converge or diverge, may wrap around the conductor carrying the electric current, and/or may be generally parallel to one another. Further, the shape of the magnetic field 40 may be selected prior to applying the magnetic field 40 to the slurry 42 in situ within the channel 20 (FIG. 4). That is, the geometry of the arrangement of the plurality of magnetic field lines 44 may be predetermined, i.e., selected or chosen, by, for example, modifying a configuration of the conductor (not shown) carrying the electric current. Stated differently, the geometry of the magnetic field 40 applied to the slurry 42 may be predetermined according to a desired shape of the operating magnetic field of the rotor 10. That is, the operating magnetic field of the rotor 10 may be tuned to have a custom, controllable 3-dimensional magnetic profile.

Referring again to FIG. 6, applying the magnetic field 40 thereby aligns the magnetic moment 38 of each permanent magnetic particle 34 along the magnetic field 40. For example, applying the magnetic field 40 may align the magnetic moment 38 of each permanent magnetic particle 34 substantially parallel to one of the plurality of magnetic field lines 44. More specifically, applying the magnetic field 40 may include rotating at least a portion of the plurality of permanent magnetic particles 34 so as to orient each magnetic moment (arrows 38 in FIGS. 5 and 6) substantially parallel to one of the plurality of magnetic field lines 44. For example, the magnetic moment 38 of some of the permanent magnetic particles 34 may originally be disposed along the predetermined geometry of the magnetic field 40 as a result of substantially filling the channel 20 with the slurry 42. Applying the magnetic field 40 in situ within the channel 20 may thereby physically rotate any permanent magnetic particle 34 having a magnetic moment 38 that is not yet aligned along the applied magnetic field 40 so that each magnetic moment 38 of each permanent magnetic particle 34 becomes oriented along one of the plurality of magnetic field lines 44, i.e., along the magnetic field 40.

The method further includes curing the polymer 36 (FIG. 5) to permanently align the magnetic moment 38 of each permanent magnetic particle 34 along the magnetic field 40 and thereby dispose the permanent magnet 24 (FIGS. 3 and 6) within the channel 20 (FIG. 3) to form the rotor 10 (FIG. 3). The permanent magnet 24 abuts the lamination stack 18 (FIG. 3) and substantially fills the channel 20, whereby the channel 20 is substantially free from an air gap 88 (FIG. 1) between the lamination stack 18 and the permanent magnet 24, as set forth in detail above.

The polymer 36 (FIG. 5) may be cured by any suitable process. In particular, curing may solidify the polymer 36 in situ within the channel 20 (FIG. 3) to thereby dispose the permanent magnet 24 within the channel 20. More specifically, although dependent upon the polymer 36 selected for a desired application of the rotor 10, curing may cross-link the polymer 36 in situ within the channel 20 to thereby dispose the permanent magnet 24 within the channel 20. By way of non-limiting examples, the polymer 36 may be cured by a curing agent such as a cross-linker, by increasing the temperature of the polymer 36, and combinations thereof.

For the method, applying the magnetic field 40 (FIG. 6) may be substantially concurrent with curing the polymer 36 (FIG. 5). That is, the magnetic field 40 may be applied to the slurry 42 (FIG. 5) in situ within the channel 20 (FIG. 3) while the polymer 36 is curing. Applying the magnetic field 40 concurrently with curing allows the plurality of permanent magnetic particles 34 to permanently align, e.g., to rotate into a permanent orientation, so that the magnetic moment 38 of each permanent magnetic particle 34 is aligned along the magnetic field 40. After the polymer 36 is cured, each magnetic moment 38 is thereby permanently aligned along, e.g., substantially parallel to, one of the plurality of magnetic field lines 44 (FIG. 6) of the magnetic field 40.

Therefore, for the method, the rotor 10 may be formed without inserting individual bonded magnets 86 (FIG. 1) having a rectilinear shape and/or cross-section into the channels 20 (FIG. 4) defined by the lamination stack 18 (FIG. 4). Rather, the permanent magnet 24 may be disposed within each channel 20 simultaneously via an automated system, e.g., the injection nozzle 46 (FIG. 4) set forth above. Such automation provides cost and time savings as compared to a method including hand-inserting individual preformed rectilinear magnets 86 within each channel 20.

In one example, also described with reference to FIGS. 3-6, the method includes combining the polymer 36 (FIG. 5) and the plurality of permanent magnetic particles 34 (FIG. 5) each having a magnetic moment 38 (FIG. 5) to form the slurry 42 (FIG. 5). The method further includes injecting the slurry 42 in a liquid phase into each of the plurality of channels 20 (FIG. 4) defined by the lamination stack 18 (FIG. 3) to thereby substantially fill each channel 20 with the slurry 42, wherein the plurality of channels 20 is arranged annularly about the central longitudinal rotor axis 16 and each channel 20 has a curvilinear cross-section, as shown in FIG. 3.

After injecting, the method includes applying the magnetic field 40 (FIG. 6) having the plurality of magnetic field lines 44 arranged in the predetermined geometry to the slurry 42 (FIG. 5) in situ within each channel 20 (FIG. 4) to thereby rotate at least a portion of the plurality of permanent magnetic particles 34 (FIGS. 5 and 6) so as to orient the magnetic moment 38 (FIG. 6) of each permanent magnetic particle 34 along the magnetic field 40.

Concurrent with applying, the method includes curing the polymer 36 (FIG. 5) in situ within each channel 20 (FIG. 3) to permanently align the magnetic moment 38 of each permanent magnetic particle 34 along the magnetic field 40 and thereby dispose the permanent magnet 24 (FIGS. 3 and 6) having a curvilinear cross-section within each channel 20. Referring to FIG. 3, the permanent magnet 24 abuts the lamination stack 18 and substantially fills each channel 20 whereby each channel 20 is substantially free from an air gap 88 (FIG. 1) between the lamination stack 18 and the permanent magnet 24.

After curing, as described with reference to FIG. 6, the method includes removing the magnetic field 40 from the permanent magnet 24 without rotation of any of the permanent magnetic particles 34 to thereby form the rotor 10 (FIG. 3). For example, the magnetic field 40 may be removed by interrupting the electrical current flowing through the aforementioned conductor or by disposing the lamination stack 18 (FIG. 3) away from an external magnet. Therefore, the permanent magnet 24 of FIG. 3 exhibits permanent magnetization and does not demagnetize upon removal of the magnetic field 40. Further, each of the permanent magnetic particles 34 does not re-rotate after removal of the magnetic field 40 so as to be misaligned with the predetermined geometry of the magnetic field 40.

The method enables the formation of the rotor 10 having custom, controllable 3-dimensional magnetic profiles. That is, since the rotor 10 includes the permanent magnet 24 having a curvilinear cross-section, the magnetic field 40 of the rotor 10 may be tailored for a desired application, and torque ripple may be reduced. Further, since the rotor 10 is substantially free from air gaps 88 between the lamination stack 18 and the permanent magnet 24, the rotor 10 exhibits the same magnetic flux from a lesser quantity of permanent magnetic particles 34 without sacrificing torque output. The method also enables efficient and cost-effective manufacturing of the rotor 10 since the rotor 10 does not include discreet, rectilinear magnets 86 within the channels 20 of the rotor 10 that require tedious hand-assembly.

While the best modes for carrying out the disclosure have been described in detail, those familiar with the art to which this disclosure relates will recognize various alternative designs and embodiments for practicing the disclosure within the scope of the appended claims.

1. A rotor for an electromagnetic device, the rotor comprising:
a lamination stack defining a plurality of channels therethrough, wherein said plurality of channels is arranged annularly about a central longitudinal rotor axis and wherein each channel has a curvilinear cross-section; and
a plurality of permanent magnets disposed respectively within each channel whereby each channel is substantially filled with said permanent magnet;
wherein each of said permanent magnets includes a plurality of permanent magnetic particles dispersed within a polymer and each having a magnetic moment permanently aligned along a magnetic field.

2. The rotor of claim 1, wherein each of said permanent magnets abuts said lamination stack whereby each channel is substantially free from an air gap between said lamination stack and said permanent magnet.

3. The rotor of claim 1, wherein each of said permanent magnets has a curvilinear cross-section within each channel in a plane substantially parallel to said central longitudinal rotor axis.

4. The rotor of claim 3, wherein each of said permanent magnets has a curvilinear cross-section within each channel in a plane substantially perpendicular to said central longitudinal rotor axis.

5. The rotor of claim 1, wherein each of said permanent magnets has a curvilinear cross-section within each channel in a plane substantially perpendicular to said central longitudinal rotor axis.

6. The rotor of claim 1, wherein each of said plurality of channels has a substantially similar shape.

7. The rotor of claim 1, wherein each of said plurality of channels is substantially equally spaced apart from each of two adjacent channels.

8. The rotor of claim 1, wherein each of said plurality of permanent magnetic particles has a particle size of from about 10 microns to about 40 microns.

9. The rotor of claim 1, wherein said polymer has a melting point temperature of greater than about 300° C.

10. A method of forming a rotor of an electromagnetic device, the method comprising:
substantially filling a channel defined by a lamination stack and having a curvilinear cross-section with a slurry including a polymer and a plurality of permanent magnetic particles, wherein each permanent magnetic particle has a magnetic moment;
applying a magnetic field having a plurality of magnetic field lines arranged in a predetermined geometry to the slurry in situ within the channel to thereby align the magnetic moment of each permanent magnetic particle along the magnetic field; and
curing the polymer to permanently align the magnetic moment of each permanent magnetic particle along the magnetic field and thereby dispose a permanent magnet within the channel to form the rotor;
wherein the permanent magnet abuts the lamination stack and substantially fills the channel whereby the channel is substantially free from an air gap between the lamination stack and the permanent magnet.

11. The method of claim 10, wherein said applying is substantially concurrent with said curing.

12. The method of claim 10, wherein said applying includes rotating at least a portion of the plurality of permanent magnetic particles so as to orient each magnetic moment substantially parallel to one of the plurality of magnetic field lines.

13. The method of claim 10, wherein said substantially filling includes injecting the slurry into the channel in a liquid phase under pressure.

14. The method of claim 13, wherein said substantially filling includes injecting the slurry into the channel without heating the slurry above ambient temperature.

15. The method of claim 10, wherein said curing solidifies the polymer in situ within the channel to thereby dispose the permanent magnet within the channel.

16. The method of claim 10, wherein said curing cross-links the polymer in situ within the channel to thereby dispose the permanent magnet within the channel.

17. A method of forming a rotor of an electromagnetic device, the method comprising:
combining a polymer and a plurality of permanent magnetic particles each having a magnetic moment to form a slurry;
injecting the slurry in a liquid phase into each of a plurality of channels defined by a lamination stack to thereby substantially fill each channel with the slurry, wherein the plurality of channels is arranged annularly about a central longitudinal rotor axis and each channel has a curvilinear cross-section;
after injecting, applying a magnetic field having a plurality of magnetic field lines arranged in a predetermined geometry to the slurry in situ within each channel to thereby rotate at least a portion of the plurality of permanent magnetic particles so as to orient the magnetic moment of each permanent magnetic particle along the magnetic field;
concurrent with applying, curing the polymer in situ within each channel to permanently align the magnetic moment of each permanent magnetic particle along the magnetic field and thereby dispose a permanent magnet having a curvilinear cross-section within each channel, wherein the permanent magnet abuts the lamination stack and substantially fills each channel whereby each channel is substantially free from an air gap between the lamination stack and the permanent magnet; and
after curing, removing the magnetic field from the permanent magnet without rotation of any of the permanent magnetic particles to thereby form the rotor.
